(19) United States
(12) Patent Application Publication
(10) Pub. No.: US 2026/0361512 A1
(43) Pub. Date: Nov. 12, 2026

(54) ESTABLISHING OWNERSHIP FOR RADIO FREQUENCY IDENTIFICATION TAGS ASSOCIATED WITH PRODUCTS

(71) Applicant: QUALCOMM Incorporated, San Diego, CA (US)

(72) Inventors: Soo Bum LEE, San Diego, CA (US); Gavin Bernard HORN, La Jolla, CA (US); Joseph Patrick BURKE, Carlsbad, CA (US)

(21) Appl. No.: 19/203,485

(22) Filed: May 9, 2025

(51) Int. Cl. H04L 9/08; H04L 9/32

(52) U.S. Cl. CPC H04L 9/0816; H04L 9/3213; H04L 9/3228

(57) ABSTRACT

In some aspects, a device associated with a product owner or a product merchant may obtain one or more security keys. The device may communicate, to at least one of a radio frequency identification (RFID) tag that is associated with a product, one or more devices, a provisioning service, or a device manufacturer, one or more messages during a lifetime of the product, wherein the one or more messages enable a change of ownership of the product during the lifetime of the product based at least in part on the one or more security keys. Numerous other aspects are described.

### FIELD OF THE DISCLOSURE

Aspects of the present disclosure generally relate to radio frequency identification (RFID) tags and, for example, to establishing ownership for RFID tags associated with products.

### BACKGROUND

Radio frequency identification (RFID) is a technology that uses electromagnetic fields to automatically identify and track tags attached to objects. A system may include an RFID tag, which contains electronically stored information, and an RFID reader, which may emit radio waves to communicate with the RFID tag. When the RFID tag comes within the range of the RFID reader, the RFID tag may transmit stored data back to the RFID reader. RFID tags may be passive, active, or semi-passive, depending on their power source and range capabilities. RFID technology may be used in various applications, including inventory management, asset tracking, access control, and supply chain logistics, due to its ability to provide real-time data and improve operational efficiency.

### SUMMARY

In some implementations, an apparatus at a radio frequency identification (RFID) tag that is associated with a product includes one or more components configured to cause the RFID tag to: obtain one or more security keys; and communicate, to at least one of one or more devices, a provisioning service, or a device manufacturer, one or more messages during a lifetime of the product, wherein the one or more messages enable a change of ownership of the product during the lifetime of the product based at least in part on the one or more security keys.

In some implementations, a method includes obtaining, by an RFID tag that is associated with a product, one or more security keys; and communicating, by the RFID tag to at least one of one or more devices, a provisioning service, or a device manufacturer, one or more messages during a lifetime of the product, wherein the one or more messages enable a change of ownership of the product during the lifetime of the product based at least in part on the one or more security keys.

In some implementations, a non-transitory computer-readable medium storing a set of instructions comprising: one or more instructions that, when executed by one or more components of an RFID tag that is associated with a product, cause the RFID tag to: obtain one or more security keys; and communicate, to at least one of one or more devices, a provisioning service, or a device manufacturer, one or more messages during a lifetime of the product, wherein the one or more messages enable a change of ownership of the product during the lifetime of the product based at least in part on the one or more security keys.

In some implementations, an apparatus includes means for obtaining one or more security keys; and means for communicating, to at least one of one or more devices, a provisioning service, or a device manufacturer, one or more messages during a lifetime of a product, wherein the one or more messages enable a change of ownership of the product during the lifetime of the product based at least in part on the one or more security keys.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example associated with an ownership change.

FIG. 2 is a diagram of an example associated with an ownership establishment.

FIG. 3 is a diagram of an example associated with an ownership transfer.

FIG. 4 is a diagram of an example associated with an ownership transfer.

FIG. 5 is a diagram of an example associated with an ownership release.

FIG. 6 is a diagram of an example associated with an ownership change.

FIG. 7 is a diagram of an example associated with an ownership change.

FIG. 8 is a diagram illustrating example components of a device.

FIG. 9 is a flowchart of an example process associated with establishing ownership for radio frequency identification tags associated with products.

FIG. 10 is a flowchart of an example process associated with establishing ownership for radio frequency identification tags associated with products.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A radio frequency identification (RFID) or an electronic product code (EPC) may be a product code that is typically attached to a package or box. EPC is a standard identifier (ID) format used in RFID, whereas RFID refers to a technology encompassing aspects of radio frequency (RF) identification. “RFID” and “EPC” may be used interchangeably herein. The RFID or the EPC may be used for inventory management. When security is needed, a secret key for the RFID may be programmed once (e.g., during a manufacturing time). The RFID may be disabled when not needed (e.g., when a product associated with the RFID is purchased at a retail store). When the RFID is disabled, there may be no need for inventory management.

An embedded RFID or an embedded EPC in a product may be used for post-purchase product tracking. An embedded RFID tag (or an RFID tag) is a device that that is integrated into the product during a manufacturing process. Unlike traditional RFID tags that are attached externally, embedded RFID tags may be embedded within the product itself, making the embedded RFID tags less susceptible to damage or removal. The embedded RFID tag may be used for inventory management. The embedded RFID tag may be used to track products throughout a supply chain. The embedded RFID tag may also be used for the post-purchase product tracking. For example, the embedded RFID tag may be used to track products even after the products have been purchased by consumers, which may be useful for warranty management, product recalls, and providing personalized customer service.

During a product lifetime, an ownership of the product (which contains the embedded RFID or the embedded EPC) may change multiple times. For example, during the product lifetime, the ownership of the product may change from a manufacturer to a wholesale/retail store. The ownership may then change from the wholesale/retail store to a first consumer. The ownership may then change from the first consumer to consumer n, where n is a positive integer. The product lifetime and/or use cases may affect or determine RFID capabilities or security requirements. For example, the use cases may include disposable goods after short-term use, long lifetime non-electronic goods, or long lifetime electronic devices. A single solution with respect to ownership management may not fit to all types of devices/goods. Further, such solutions may not provide a requisite amount of security, which may be needed when supporting ownership changes for embedded RFIDs. An inability to handle different types of use cases for different types of devices/goods and an inability to provide a proper level of security when managing ownership changes of products associated with embedded RFIDs may degrade an overall system performance.

In some aspects, an ownership of RFID-tagged products may be managed in an inventory system. The ownership of RFID-tagged products may be changed due to business-consumer transactions. An RFID or an EPC may be embedded in products. An initial ownership may be established at a merchant level using a provisioning service. The initial ownership may involve a device key and an authentication key to securely define an ownership key with the RFID, which may enhance inventory management and security.

In some aspects, an embedded RFID with support of ownership change may involve employing various security mechanisms. A common framework/platform that covers a wide range of use cases may be employed for RFID-based ownership management. The common framework/platform may support different options depending on scenarios or uses cases, as well as device (e.g., RFID) capabilities and complexity. The common framework/platform may provide enhanced security when managing ownership changes of products associated with embedded RFIDs, thereby improving an overall system performance.

In some aspects, the common framework/platform may enhance the security and efficiency of RFID ownership transfer processes by employing cryptographic techniques and secure communication protocols, which may minimize the risk of unauthorized tag access and data breaches. Such an approach may conserve network resources by streamlining the transfer of ownership data between parties, and the approach may reduce a computational overhead through optimized key distribution mechanisms. The common framework/platform may facilitate accurate inventory management and ownership tracking for manufacturers and merchants, which may result in improved supply chain efficiency. The common framework/platform's capability to handle various transaction scenarios with enhanced security mechanisms may conserve processing resources, as the need for repeated authentication checks and ownership verifications may be reduced.

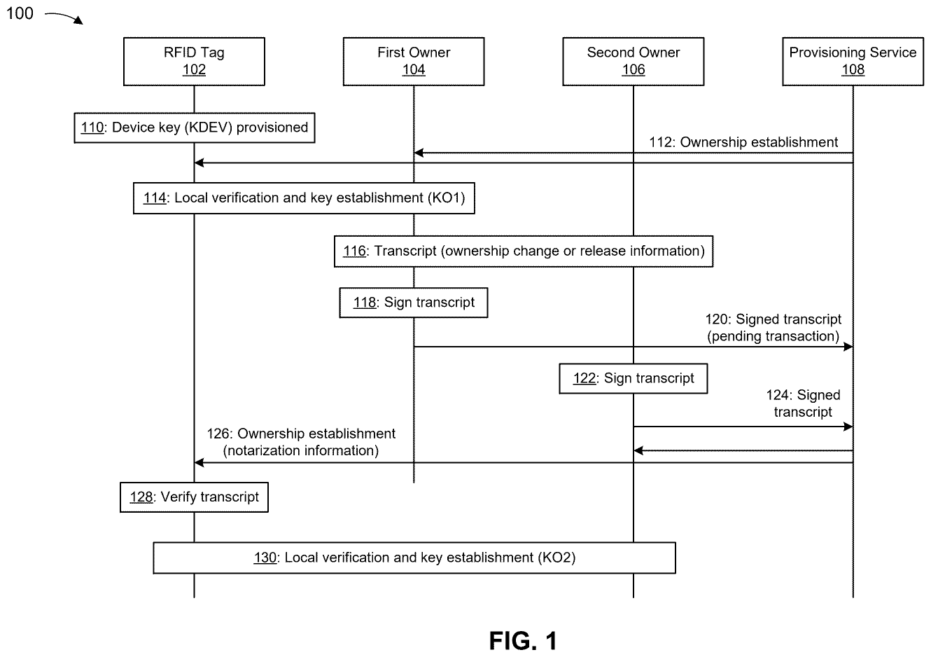

FIG. 1 is a diagram of an example 100 associated with an ownership change. As shown in FIG. 1, the example 100 may include an RFID tag 102, a first owner 104, a second owner 106, and a provisioning service 108. The RFID tag 102 may be associated with a product. The RFID tag 102 may be an embedded RFID tag. The first owner 104 may be associated with a first device (e.g., a first RFID reader) and the second owner 106 may be associated with a second device (e.g., a second RFID reader). For example, actions associated with the first owner 104 may be performed using the first device, and actions associated with the second owner 106 may be performed using the second device. The provisioning service 108 may be run by a manufacturer, a retailer, or a trusted third party. The provisioning service 108 may be associated with one or more devices.

In some aspects, the RFID tag 102 and the provisioning service 108 may communicate with each other over a network. The network may include one or more wired and/or wireless networks. For example, the network may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks.

In some aspects, as part of a shared key option, the manufacturer may provision a device key (e.g., a long-term secret) at the RFID tag 102. The device key may be used to derive or program an owner key. During an ownership transition between the first owner 104 and the second owner 106, the first owner 104 (e.g., a current owner) may sign a transcript releasing an RFID ownership, which may be verified by the provisioning service 108. The second owner 106 (e.g., a new owner) may sign the transcript obtaining the RFID ownership, which may be verified by the provisioning service 108. The signed transcript may be notarized by the provisioning service 108 (e.g., a third party). The provisioning service 108 may start a new ownership establishment procedure. The RFID tag 102 may install and/or update new ownership information, after notarized information is verified. After ownership of the RFID tag 102 is transferred to the second owner 106, the second owner 106 may permanently disable the RFID tag 102 or relinquish ownership.

As shown by reference number 110, the device key (K_{DEV}) may be provisioned at the RFID tag 102. The device key is available and/or provisioned at the provisioning service 108 (e.g., the same key may be available at the provisioning service 108). The device key may be associated with the long-term secret. For example, the manufacturer may provision the device key at the RFID tag 102. As shown by reference number 112, the provisioning service 108 may perform an ownership establishment with the RFID tag 102 and the first owner 104. As shown by reference number 114, the RFID tag 102 and the first owner 104 may perform a local verification and a key establishment, which may result in a first owner key (KO1) being established. The device key may be used to derive or program the first owner key. The first owner key may be maintained by the RFID tag 102. The first owner key also may be maintained by the first owner 104.

As shown by reference number 116, the first owner 104 and the second owner 106 may exchange a transcript, which may be associated with an ownership change or release information. The ownership change may involve a change of ownership of the RFID tag 102 (or the product associated with the RFID tag 102) from the first owner 104 to the second owner 106. As shown by reference number 118, the first owner 104 may sign the transcript. As shown by reference number 120, the first owner 104 may transmit the signed transcript to the provisioning service 108, at which point a pending transaction may exist at the provisioning service 108. As shown by reference number 122, the second owner 106 may sign the transcript. As shown by reference number 124, the second owner 106 may transmit the signed transcript to the provisioning service 108.

As shown by reference number 126, the provisioning service 108 may perform an ownership establishment with the RFID tag 102 and the second owner 106. The ownership establishment may involve transmitting the notarization information. As shown by reference number 128, the RFID tag 102 may verify the transcript and the notarization information. As shown by reference number 130, the RFID tag 102 and the second owner 106 may perform a local verification and a key establishment, which may result in a second owner key (KO2) being established. The second owner key may be maintained by the RFID tag 102. The second owner key may also be maintained by the second owner 106.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

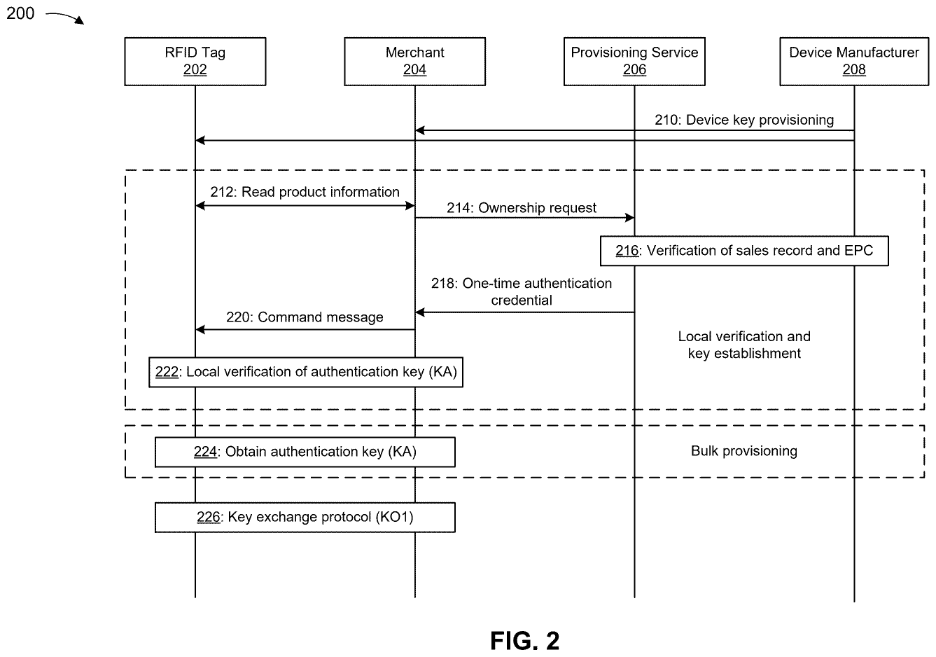

FIG. 2 is a diagram of an example 200 associated with an ownership establishment. As shown in FIG. 2, the example 200 may include an RFID tag 202, a merchant 204, a provisioning service 206, and a device manufacturer 208. The RFID tag 202 may be associated with a product. The RFID tag 202 may be an embedded RFID tag. The merchant 204 may be associated with a device, such as an RFID reader. For example, actions associated with the merchant 204 may be performed using the device. The provisioning service 206 may be associated with one or more devices. The device manufacturer 208 may be associated with one or more devices.

In some aspects, an ownership establishment may involve a business-to-business (B2B) scenario (e.g., an initial ownership establishment at the merchant 204). The provisioning service 206 may be a hub that facilitates an ownership management between the device manufacturer 208 and the merchant 204. A device key (K_{DEV}) may be provisioned at the RFID tag 202 (e.g., at the product associated with the RFID tag 202) and supplied to the provisioning service 206. Alternatively, device manufacturer 208 may leverage the provisioning service 206 for an initial provisioning. An initial ownership establishment at the merchant 204 may be unique for B2B (e.g., no preexisting owner). The merchant 204 may obtain an authentication key (K_{A}) from the provisioning service 206. The merchant 204 may generate the authentication key. Alternatively, the merchant 204 may obtain the authentication key based at least in part on a bulk provisioning (e.g., authentication keys for all RFID tags (products) may be sent). In the bulk provisioning, the authentication key may be programmed at the RFID tag 202. The merchant 204 may establishment an owner key (KO) with the RFID tag 202 based at least in part on the authentication key. The merchant 204 may install a key protected based at least in part on the authentication key. A key negotiation protocol may be run between the merchant 204 and the RFID tag 202 to establish the owner key for enhanced security with additional overhead.

As shown by reference number 210, the device manufacturer 208 may perform a device key provisioning to the RFID tag 202 and the provisioning service 206. The RFID tag 202 may maintain the device key based at least in part on the device key provisioning. The provisioning service 206 may also maintain the device key based at least in part on the device key provisioning.

As shown by reference number 212, as part of a local verification and key establishment, the merchant 204 may read product information from the RFID tag 202 associated with the product. The product information may indicate an EPC, such as a protected EPC, and/or a tag ID (TID). The EPC may be protected by the RFID tag using the device key of the RFID tag. The TID may confirm a physical ownership of the RFID tag. As shown by reference number 214, the merchant 204 may transmit an ownership request to the provisioning service 206. The ownership request may indicate the EPC, a sales record, and/or an authentication key for a new owner. The sales record may take the form of ownership release/transfer information. As shown by reference number 216, the provisioning service 206 may verify the sales record and the EPC with the device manufacturer 208. As shown by reference number 218, the provisioning service 206 may transmit a one-time authentication credential to the merchant 204. The one-time authentication credential may indicate an authorization token that provides an authorization proof of ownership transfer created using a current owner key, and an encrypted authentication key which may be based at least in part on the device key. The authorization token may be optional for the initial provisioning. As shown by reference number 220, the merchant 204 may transmit a command message to the RFID tag 202. The command message may indicate the authentication key, the authorization token, and/or the encrypted authentication key. As shown by reference number 222, the RFID tag 202 and the merchant 204 may perform a local verification of the authentication key, which may be for purposes of the ownership establishment. The RFID tag 202 may maintain the authentication key. The merchant 204 may also maintain the authentication key.

As shown by reference number 224, as part of a bulk provisioning of the authentication key, the RFID tag 202 and the merchant 204 may obtain the authentication key. The authentication key may be programmed at the RFID tag 202 as part of the bulk provisioning.

As shown by reference number 226, the RFID tag 202 and the merchant 204 may perform a key exchange protocol, such that the owner key may be established based at least in part on the key exchange protocol. The RFID tag 202 may maintain the owner key. The merchant 204 may also maintain the owner key. Alternatively, the provisioning service 206 may program the owner key into the RFID tag 202 and provide the owner key to the merchant 204 over a security channel (bulk provisioning).

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

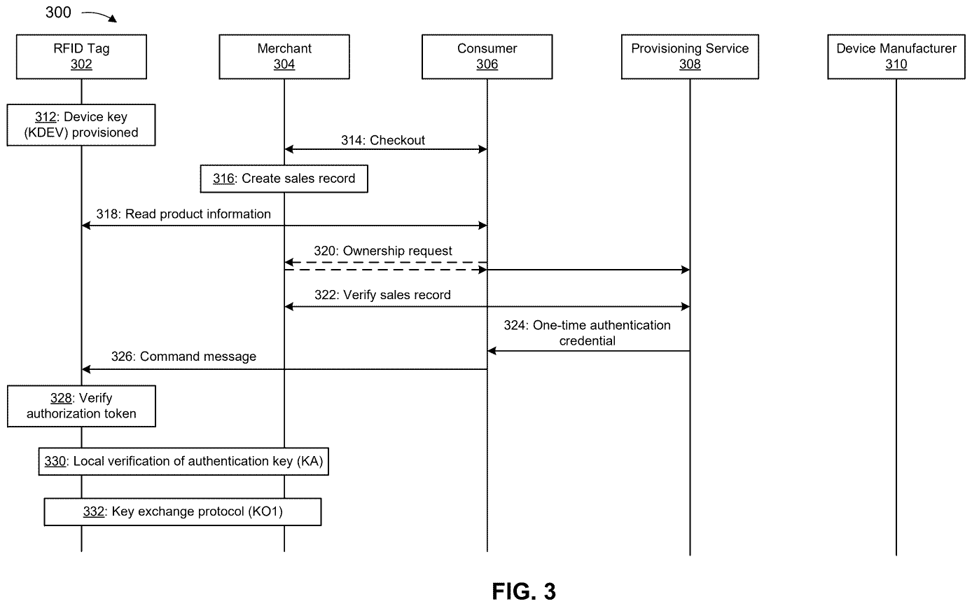

FIG. 3 is a diagram of an example 300 associated with an ownership transfer. As shown in FIG. 3, the example 300 may include an RFID tag 302, a merchant 304, a consumer 306, a provisioning service 308, and a device manufacturer 310. The RFID tag 302 may be associated with a product. The RFID tag 302 may be an embedded RFID tag. The merchant 304 may be associated with a first device (e.g., a first RFID reader) and the consumer 306 may be associated with a second device (e.g., a second RFID reader). For example, actions associated with the merchant 304 may be performed using the first device, and actions associated with the consumer 306 may be performed using the second device. The provisioning service 308 may be associated with one or more devices. The device manufacturer 310 may be associated with one or more devices.

In some aspects, an ownership establishment may involve a business-to-consumer (B2C) scenario. In the B2C scenario, the consumer 306 may trigger an ownership transfer procedure. The merchant 304 may inform the provisioning service 308 of its ownership release, which may or may not be piggybacked in the consumer's ownership request. The consumer 306 may transmit, to the provisioning service 308, a request for ownership of the RFID tag 302 (or the product associated with the RFID tag 302). The request may include a TID and/or an EPC read from the RFID tag 302, which may confirm a physical ownership of the RFID tag 302. The TID and/or the EPC may be protected by the RFID tag using the device key of the RFID tag. The request may include an authorization token created by the merchant 304. The authorization token may be based at least in part on a merchant owner key. The authorization token may not be consumed by the provisioning service 308, but rather may be consumed by the RFID tag 302. The request may include a sales record. The sales record may include a transaction number or a receipt, which may be verified by the provisioning service 308. The provisioning service 308 may interact with the merchant 304 to verify the sales record. Alternatively, a merchant signed sales record may be supplied to the consumer 306. The consumer 306 may receive an authentication key, an encrypted authentication key, and/or the authorization token from the provisioning service 308. The authentication key may be used between the consumer 306 and the RFID tag 302 to agree on a new owner key. The authentication key may be protected by the provisioning service 308 using the device key of the RFID tag as a proof/endorsement of ownership change approval. The device key may refer to a device key of the RFID tag. The authorization token may be a proof of release of ownership by the merchant 304.

As shown by reference number 312, a device key (K_{DEV}) may be provisioned at the RFID tag 302. The RFID tag 302 may maintain the device key. The provisioning service 308 may also maintain the device key. As shown by reference number 314, the consumer 306 may checkout the product associated with the RFID tag 302 from the merchant 304. As shown by reference number 316, the merchant 304 may create a sales record.

As shown by reference number 318, as part of an ownership establishment, the consumer 306 may read product information associated with the product. The consumer 306 may read the product information from the RFID tag 302. The product information may include a TID, such as a protected TID, or an EPC, such as a protected EPC, or both. As shown by reference number 320, the merchant 304 or the consumer 306 may transmit an ownership request to the provisioning service 308. The ownership request may include the TID, the EPC, the sales record, and/or an authorization token. The authorization token may be based at least in part on an authentication key. As shown by reference number 322, the merchant 304 may verify the sales record with the provisioning service 308. As shown by reference number 324, the provisioning service 308 may transmit a one-time authentication credential to the consumer 306. The one-time authentication credential may include the authorization token and an encrypted authentication key. The authentication key may be encrypted based at least in part on the device key. As shown by reference number 326, the merchant 304 may transmit a command message to the RFID tag 302. The command message may indicate the authentication key, the authorization token, and/or the encrypted authentication key. As shown by reference number 328, the RFID tag 302 may verify the authorization token.

As shown by reference number 330, the RFID tag 302, the merchant 304, and/or the consumer 306 may perform a local verification of the authentication key. The RFID tag 302 may maintain the authentication key. The consumer 306 may also maintain the authentication key. As shown by reference number 332, the RFID tag 302, the merchant 304, and/or the consumer 306 may perform a key exchange protocol, such that the owner key may be established based at least in part on the key exchange protocol. The RFID tag 302 may maintain the owner key. The consumer 306 may also maintain the owner key.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

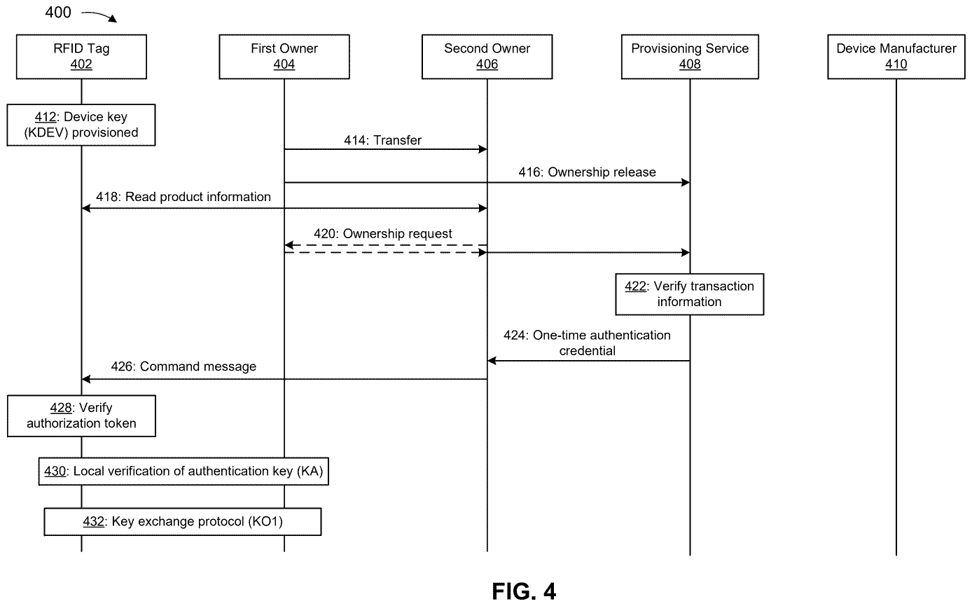

FIG. 4 is a diagram of an example 400 associated with an ownership transfer. As shown in FIG. 4, the example 400 may include an RFID tag 402, a first owner 404, a second owner 406, a provisioning service 408, and a device manufacturer 410. The RFID tag 402 may be associated with a product. The RFID tag 402 may be an embedded RFID tag. The first owner 404 may be associated with a first device (e.g., a first RFID reader) and the second owner 406 may be associated with a second device (e.g., a second RFID reader). For example, actions associated with the first owner 404 may be performed using the first device, and actions associated with the second owner 406 may be performed using the second device. The provisioning service 408 may be associated with one or more devices. The device manufacturer 410 may be associated with one or more devices.

In some aspects, an ownership establishment may involve a consumer-to-consumer (C2C) scenario. In the C2C scenario, the second owner 406 (e.g., a new owner) may trigger an ownership transfer procedure. The first owner 404 (e.g., a current owner) may inform the provisioning service 408 of its ownership release, which may or may not be piggybacked in the second owner's ownership request. The second owner 406 may transmit, to the provisioning service 408, a request for ownership of the RFID tag 402 (or the product associated with the RFID tag 402). The request may include a TID and/or an EPC read from the RFID tag 402, which may confirm a physical ownership of the RFID tag 402. The request may include an authorization token created by the first owner 404. The authorization token may be based at least in part on a current owner key. The authorization token may not be consumed by the provisioning service 408, but rather may be consumed by the RFID tag 402. The request may include a transcript, which may describe a transaction between the first owner 404 and the second owner 406. A format of the transcript may be defined by the provisioning service 408. The first owner 404 may not have an account/service with the provisioning service 408. The second owner 406 may receive an authentication key, an encrypted authentication key, and/or the authorization token from the provisioning service 408. The authentication key may be used between the second owner 406 and the RFID tag 402 to agree on a new owner key. The authentication key may be protected by the provisioning service 408 using a device key as a proof/endorsement of ownership change approval. The authorization token may be a proof of release of ownership by the first owner 404.

As shown by reference number 412, a device key (K_{DEV}) may be provisioned at the RFID tag 402. The RFID tag 402 may maintain the device key. The provisioning service 408 may also maintain the device key. As shown by reference number 414, the first owner 404 may initiate a transfer of the product associated with the RFID tag 302 to the second owner 406.

As shown by reference number 416, as part of an ownership establishment, the first owner 404 may transmit an ownership release to the provisioning service 408. The ownership release may indicate the TID, the EPC, and the transcript. As shown by reference number 418, the second owner 406 may read product information associated with the product. The second owner 406 may read the product information from the RFID tag 402. The product information may include the TID, such as a protected TID, or the EPC, such as a protected EPC. As shown by reference number 420, the first owner 404 or the second owner 406 may transmit an ownership request to the provisioning service 408. The ownership request may include the TID, the EPC, the transcript, and/or an authorization token. The authorization token may be based at least in part on an authentication key. As shown by reference number 422, the provisioning service 408 may verify transaction information. As shown by reference number 424, the provisioning service 408 may transmit a one-time authentication credential to the second owner 406. The one-time authentication credential may include the authorization token and an encrypted authentication key. The encrypted authentication key may be based at least in part on the device key. As shown by reference number 426, the second owner 406 may transmit a command message to the RFID tag 402. The command message may indicate the authentication key, the authorization token, and/or the encrypted authentication key. As shown by reference number 428, the RFID tag 402 may verify the authorization token.

As shown by reference number 430, the RFID tag 402, the first owner 404, and/or the second owner 406 may perform a local verification of the authentication key. The RFID tag 402 may maintain the authentication key. The second owner 406 may also maintain the authentication key. As shown by reference number 432, the RFID tag 402, the first owner 404, and/or the second owner 406 may perform a key exchange protocol, such that the new owner key (KO2) may be established based at least in part on the key exchange protocol. The RFID tag 402 may maintain the new owner key. The second owner 406 may also maintain the new owner key. The current owner key (KO1) may no longer be applicable after the ownership establishment with the second owner 406.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

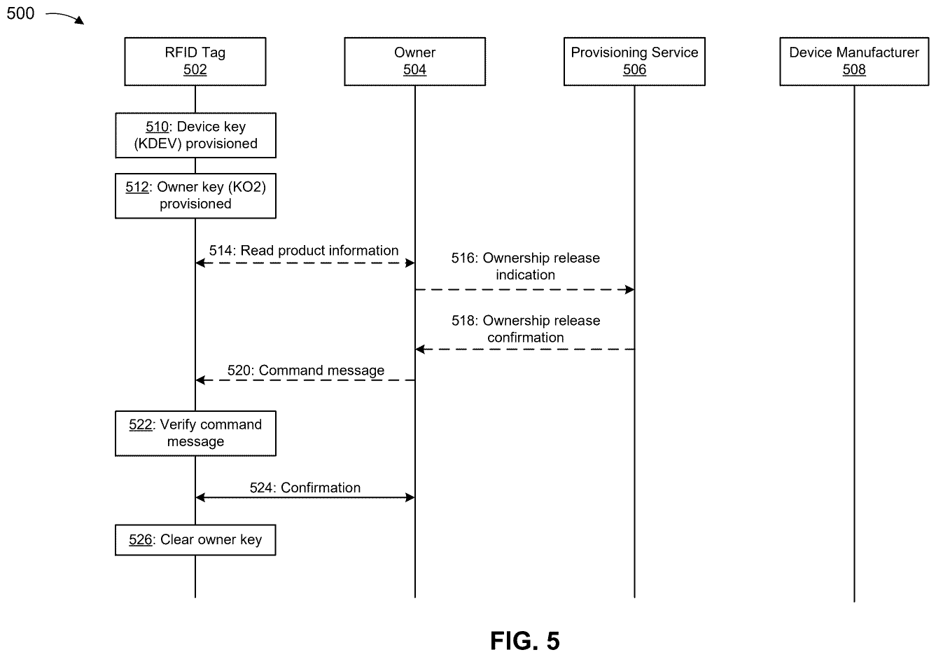

FIG. 5 is a diagram of an example 500 associated with an ownership release. As shown in FIG. 5, the example 500 may include an RFID tag 502, an owner 504, a provisioning service 506, and a device manufacturer 508. The RFID tag 502 may be associated with a product. The RFID tag 502 may be an embedded RFID tag. The owner 504 may be associated with a device (e.g., a reader). For example, actions associated with the owner 504 may be performed using the device. The provisioning service 506 may be associated with one or more devices. The device manufacturer 508 may be associated with one or more devices.

As shown by reference number 510, a device key (K_{DEV}) may be provisioned at the RFID tag 502. The RFID tag 502 may maintain the device key. The provisioning service 506 may also maintain the device key. As shown by reference number 512, an owner key (KO2) associated with the owner 504 may be provisioned at the RFID tag 502. The RFID tag 502 may maintain the owner key. The provisioning service 506 may also maintain the owner key.

As shown by reference number 514, as part of an initialization of an ownership release, the owner 504 may read product information associated with the product. The owner 504 may read the product information from the RFID tag 502. The product information may include a TID, such as a protected TID, or an EPC, such as a protected EPC. As shown by reference number 516, the owner 504 may transmit an ownership release indication to the provisioning service 506. The ownership release indication may indicate the TID and/or the EPC. As shown by reference number 518, the provisioning service 506 may transmit an ownership release confirmation to the owner 504. The ownership release confirmation may include an authorization token. As shown by reference number 520, the owner 504 may transmit a command message to the RFID tag 502. The command message may include an indication of the ownership release/initialization. The command message may also include the authorization token. As shown by reference number 522, the RFID tag 502 may verify the command message. As shown by reference number 524, the RFID tag 502 and the owner 504 may exchange a confirmation of the ownership release. As shown by reference number 526, the RFID tag 502 may clear the owner key.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

In some aspects, in a shared key option and as part of an ownership establishment, a provisioning service may help to share a key (e.g., an authentication key between an RFID tag and an owner). The shared key may be used by the RFID tag and the owner to authenticate each other. An owner key may be negotiated between the RFID tag and the owner based at least in part on the authentication key. A Diffie-Hellman (DH) protocol or other key agreement protocol may be performed for an owner key derivation. A symmetric key based protocol may be used depending on RFID capabilities. The owner key may be used to confirm an ownership transfer completion. In some aspects, owners may have a service account with the provisioning service. An owner ID or credential may be established at the provisioning service. The provisioning service may use fast identity online (FIDO) for security. The provisioning service may charge per provisioning transaction. A device key may be held by the provisioning service.

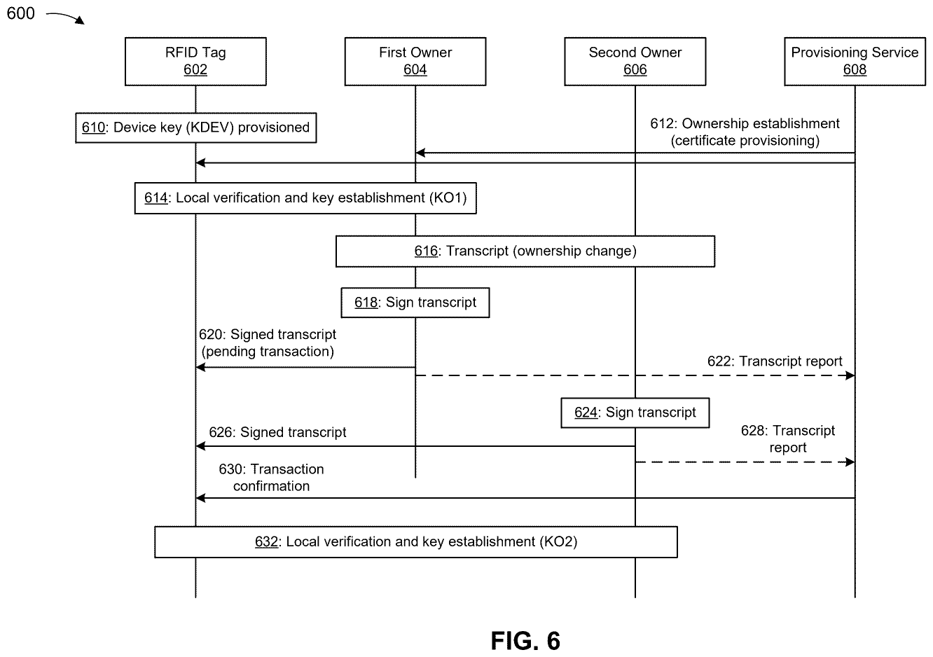

FIG. 6 is a diagram of an example 600 associated with an ownership change. As shown in FIG. 6, the example 600 may include an RFID tag 602, a first owner 604, a second owner 606, and a provisioning service 608. The RFID tag 602 may be associated with a product. The RFID tag 602 may be an embedded RFID tag. The first owner 604 may be associated with a first device (e.g., a first RFID reader) and the second owner 606 may be associated with a second device (e.g., a second RFID reader). For example, actions associated with the first owner 604 may be performed using the first device, and actions associated with the second owner 606 may be performed using the second device. The provisioning service 608 may be associated with one or more devices.

In some aspects, a public key option may utilize asymmetric key cryptographic algorithms. Information specific to the public key option may be carried or delivered in messages described in a symmetric key procedure. A manufacturer or a trusted certificate authority (CA) may provision a long-term device certificate at the RFID tag 602. A trust anchor (e.g., a manufacturer or trusted CA certificate) may be provisioned at the RFID tag 602. An owner certificate may be provisioned at the RFID tag 602. The owner certificate may be trust anchor signed or self-signed. In an ownership transition, the first owner 604 (e.g., a current owner) may sign a transcript releasing an RFID ownership or transferring an RFID ownership to a second owner. The transcript may be verified by the RFID tag 602 based at least in part on the owner certificate. A new owner certificate may be provisioned at the RFID tag 602. The new owner certificate may be signed by the first owner 604. The second owner 606 (e.g., a new owner) may sign the transcript in order to obtain the RFID ownership. The transcript may be verified by the RFID tag 602 using the new owner certificate. The signed transcript may be notarized by the provisioning service 608 (e.g., a third party). The RFID tag 602 may install or update new ownership information after verifying notarized information. The second owner 606 may be able to permanently disable the RFID tag 602.

As shown by reference number 610, a device key (K_{DEV}) may be provisioned at the RFID tag 602. The device key may be maintained by the RFID tag 602. The device key may also be maintained by the provisioning service 608. As shown by reference number 612, the provisioning service 608 may perform an ownership establishment with the RFID tag 602 and the first owner 604. The ownership establishment may include a certificate provisioning. As shown by reference number 614, the RFID tag 602 and the first owner 604 may perform a local verification and a key establishment, which may result in a first owner key (KO1) being established. The first owner key may be maintained by the RFID tag 602. The first owner key may also be maintained by the first owner 604.

As shown by reference number 616, the first owner 604 and the second owner 606 may exchange a transcript, which may be associated with an ownership change. The ownership change may involve a change of ownership of the RFID tag 602 (or the product associated with the RFID tag 602) from the first owner 604 to the second owner 606. As shown by reference number 618, the first owner 604 may sign the transcript. As shown by reference number 620, the first owner 604 may transmit the signed transcript to the RFID tag 602, at which point a pending transaction may exist at the RFID tag 602. As shown by reference number 622, the first owner 604 may transmit a transcript report to the provisioning service 608. As shown by reference number 624, the second owner 606 may sign the transcript. As shown by reference number 626, the second owner 606 may transmit the signed transcript to the RFID tag 602. As shown by reference number 628, the second owner 606 may transmit a transcript report to the provisioning service 608.

As shown by reference number 630, the provisioning service 608 may approve the transaction and transmit a transaction confirmation to the RFID tag 602. The transaction confirmation may be protected (or signed) using the device key. The provisioning service 608 may approve the transaction based at least in part on respective transcript reports received from the first owner 604 and the second owner 606. The RFID tag 602 may determine that the transaction is complete based at least in part on the transaction confirmation. As shown by reference number 632, the RFID tag 602 and the second owner 606 may perform a local verification and a key establishment, which may result in a second owner key (KO2) being established. The second owner key may be maintained by the RFID tag 602. The second owner key may also be maintained by the second owner 606.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of environment 600 may perform one or more functions described as being performed by another set of devices of environment 600.

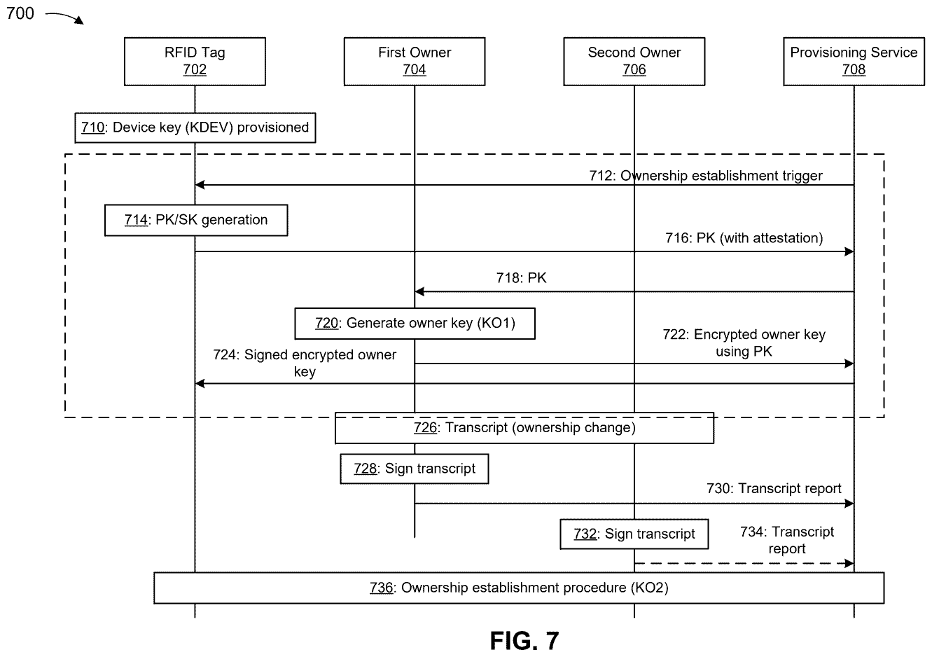

FIG. 7 is a diagram of an example 700 associated with an ownership change. As shown in FIG. 7, the example 700 may include an RFID tag 702, a first owner 704, a second owner 706, and a provisioning service 708. The RFID tag 702 may be associated with a product. The RFID tag 702 may be an embedded RFID tag. The first owner 704 may be associated with a first device (e.g., a first RFID reader) and the second owner 706 may be associated with a second device (e.g., a second RFID reader). For example, actions associated with the first owner 704 may be performed using the first device, and actions associated with the second owner 706 may be performed using the second device. The provisioning service 708 may be associated with one or more devices.

In some aspects, a public key option may utilize asymmetric keys with less overhead by leveraging the provisioning service 708. Information specific to the public key option may be carried or delivered in messages described in a symmetric key procedure. A trust anchor (e.g., a manufacturer or trusted CA certificate) may be provisioned at the RFID tag 702. The trust anchor may be a proxy helping to establish ownership. The RFID tag 702 may only need to trust the trust anchor. As part of an ownership establishment procedure, an RFID public key may be verified by the provisioning service 708 based at least in part on a remote attestation. No certificate may be needed at the RFID tag 702. The public key may be generated by the RFID tag 702. The RFID public key may be provided to the first owner 704. The first owner 704 may encrypt a first owner key (KO1) using the RFID public key, and the first owner 704 may transmit the first owner key to the provisioning service 708. The provisioning service 708 may sign the encrypted owner key, and the provisioning service 708 may transmit the encrypted owner key to the RFID tag 702. The RFID tag 702 may verify a key provisioning using a certificate of the provisioning service 708. In other words, the RFID tag 702 may verify the first owner key. In an ownership transition, the first owner 704 (e.g., a current owner) may sign a transcript releasing an RFID ownership. The second owner 706 (e.g., a new owner) may sign the transcript to obtain the RFID ownership. The provisioning service 708 may trigger an ownership establishment procedure.

As shown by reference number 710, a device key (K_{DEV}) may be provisioned at the RFID tag 702. The device key may be maintained by the RFID tag 702. The device key may also be maintained by the provisioning service 708. As shown by reference number 712, as part of an ownership establishment procedure, the provisioning service 708 may transmit an ownership establishment trigger to the RFID tag 702. As shown by reference number 714, the RFID tag 702 may generate a public key (PK) and a private key (SK). The PK and the SK are paired in asymmetric key cryptography. The SK is a secret to a key owner. As shown by reference number 716, the RFID tag 702 may transmit the public key (with attestation) to the provisioning service 708. As shown by reference number 718, the provisioning service 708 may transmit the public key to the first owner 704. As shown by reference number 720, the first owner 704 may generate the first owner key and encrypt the first owner key using the public key. As shown by reference number 722, the first owner 704 may transmit the encrypted owner key to the provisioning service 708. For example, the first owner 704 may encrypt the first owner key using the public key in order to obtain the encrypted owner key. As shown by reference number 724, the provisioning service 708 may sign the encrypted owner key, and the provisioning service 708 may may transmit the signed encrypted owner key to the RFID tag 702. The RFID tag 702 may obtain the first owner key based at least in part on the signed encrypted owner key received from the provisioning service 708. The RFID tag 702 may verify the signed encrypted owner key using the trust anchor key (e.g., the certificate of the provisioning service 708). The RFID tag 702 may decrypt the encrypted owner key using the SK.

As shown by reference number 726, the first owner 704 and the second owner 706 may exchange a transcript, which may be associated with an ownership change. The ownership change may involve a change of ownership of the RFID tag 702 (or the product associated with the RFID tag 702) from the first owner 704 to the second owner 706. As shown by reference number 728, the first owner 704 may sign the transcript. As shown by reference number 730, the first owner 704 may transmit a transcript report to the provisioning service 708. As shown by reference number 732, the second owner 706 may sign the transcript. As shown by reference number 734, the second owner 706 may transmit a transcript report to the provisioning service 708. As shown by reference number 736, the RFID tag 702, the second owner 706, and/or the provisioning service 708 may perform an ownership establishment procedure, which may result in a second owner key (KO2) being established. The second owner key may be maintained by the RFID tag 702. The second owner key may also be maintained by the second owner 706.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of environment 700 may perform one or more functions described as being performed by another set of devices of environment 700.

In some aspects, in a public key option and as part of an ownership establishment, one precondition may be that a manufacturer certificate or a CA certificate is installed on an RFID tag in an initial provisioning (e.g., by a manufacturer). A provisioning service may install an owner certificate. The owner certificate may be a self-signed certificate or a CA signed certificate. An owner certificate verification may confirm an ownership establishment. An owner key may be established between the RFID tag and an owner. A DH protocol or another protocol may be used for an owner key derivation. An efficient key provisioning may be used depending on RFID capabilities. In some aspects, owners may have a service account with the provisioning service. An owner ID or credential may be established at the provisioning service. The owner certificate may be signed by the provisioning service. The owner may request an additional CA certificate provisioning at the RFID tag. The provisioning service may charge per provisioning certificate or trusted anchor. A device certificate may be issued by the provisioning service. The provisioning service may provide a trusted anchor provisioning or transaction confirmation as a service. The provisioning service may provide an ownership establishment service in case of a lost owner certificate.

In some aspects, a comparative analysis may be performed between symmetric keys versus asymmetric keys. The comparative analysis may be between a shared key, a first public key (e.g., a public key associated with a first option), and a second public key (e.g., a public key associated with a second option).

In some aspects, the shared key may be associated with a 128 bit advanced encryption standard (AES) algorithm. The shared key may be a long term key (128 bits), an owner key (128 bits), and/or other owner defined keys (128×k bits, where k is a positive integer). The shared key may be associated with a relatively simple algorithm complexity (e.g., AES may be reused). The shared key may be associated with a relatively low storage requirement (e.g., low storage requirement proportional to key size). The shared key may be associated with a relatively low communication protocol overhead. The shared key may be associated with a per-transaction service fee. The shared key may be associated with trust on a provisioning server. The provisioning server, if intended, may impersonate an owner (e.g., by compromising local provisional steps).

In some aspects, the first public key may be associated with a 256 bit elliptic curve cryptography (ECC) algorithm. The first public key may be a device public key (256 bits) or a device private key (256 bits). The first public key may be associated with a trust anchor certificate (768×k bits). The first public key may be associated with a relatively complex algorithm complexity. The first public key may be associated with a relatively high storage requirement (e.g., due to a number of trust anchors). The first public key may be associated with a relatively low communication protocol overhead. The first public key may be associated with a per-trust-anchor provisioning service fee. The first public key may be associated with more peer-to-peer (P2P) trust. For example, a private key may only be known at a device (RFID), which may offer a non-repudiation property.

In some aspects, the second public key may be associated with a 256 bit ECC algorithm. The second public key may be a device public key (256 bits) or a device private key (256 bits). The second public key may be associated with a trust anchor public key (256 bits or more). The second public key may be associated with a less complex algorithm complexity as compared to the first public key. The second public key may be associated with a medium storage requirement. The second public key may be associated with a medium communication protocol overhead. The second public key may be associated with a key provisioning service fee. The second public key may be associated with a simple trust (e.g., end-to-end (E2E) between RFID and provisioning service). For example, a private key may only be known at a device (RFID), which may offer a non-repudiation property.

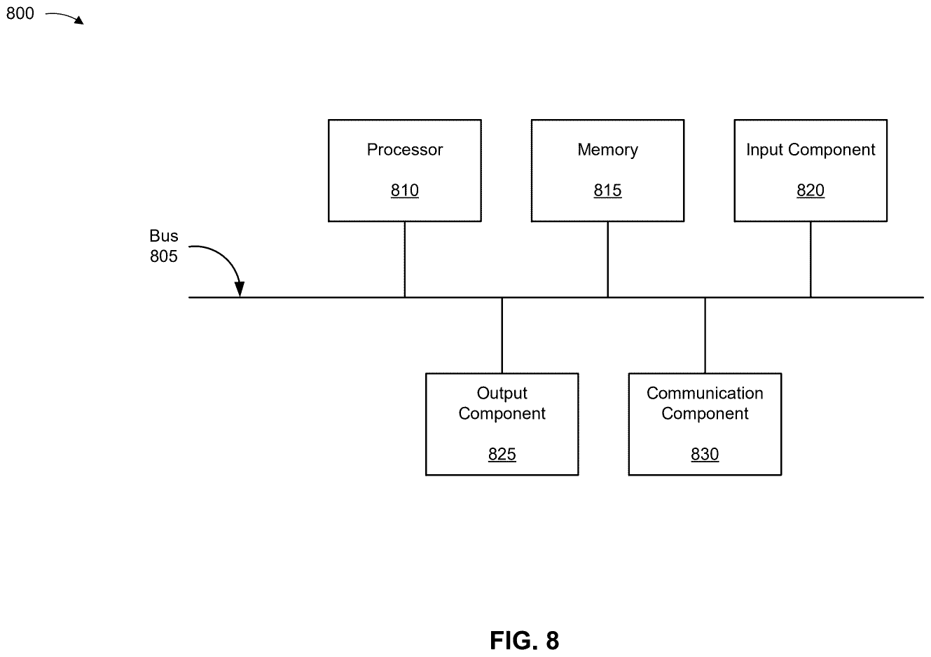

FIG. 8 is a diagram illustrating example components of a device 800. The device 800 may correspond to an RFID tag (e.g., an RFID tag as shown in FIGS. 1-7) that is associated with a product. In some aspects, the RFID tag may include one or more devices 800 or one or more components of the device 800. As shown in FIG. 8, the device 800 may include a bus 805, a processor 810, a memory 815, an input component 820, an output component 825, or a communication component 830.

The bus 805 may include one or more components that enable wired or wireless communication among the components of the device 800. The bus 805 may couple together two or more components of FIG. 8, such as via operative coupling, communicative coupling, electronic coupling, or electric coupling. For example, the bus 805 may include an electrical connection (e.g., a wire, a trace, or a lead) or a wireless bus. The processor 810 may include a central processing unit, a graphics processing unit, a microprocessor, a controller, a microcontroller, a digital signal processor, a field-programmable gate array, an application-specific integrated circuit, or another type of processing component. The processor 810 may be implemented in hardware, firmware, or a combination of hardware and software. In some aspects, the processor 810 may include one or more processors capable of being programmed to perform one or more operations or processes described elsewhere herein.

The memory 815 may include volatile or nonvolatile memory. For example, the memory 815 may include random access memory (RAM), read only memory (ROM), a hard disk drive, or another type of memory (e.g., a flash memory, a magnetic memory, or an optical memory). The memory 815 may include internal memory (e.g., RAM, ROM, or a hard disk drive) or removable memory (e.g., removable via a universal serial bus connection). The memory 815 may be a non-transitory computer-readable medium. The memory 815 may store information, one or more instructions, or software (e.g., one or more software applications) related to the operation of the device 800. In some aspects, the memory 815 may include one or more memories that are coupled (e.g., communicatively coupled) to one or more processors (e.g., processor 810), such as via the bus 805. Communicative coupling between a processor 810 and a memory 815 may enable the processor 810 to read or process information stored in the memory 815 or to store information in the memory 815.

The input component 820 may enable the device 800 to receive input, such as user input or sensed input. For example, the input component 820 may include a touch screen, a keyboard, a keypad, a mouse, a button, a microphone, a switch, a sensor, a global positioning system sensor, a global navigation satellite system sensor, an accelerometer, a gyroscope, or an actuator. The output component 825 may enable the device 800 to provide output, such as via a display, a speaker, or a light-emitting diode. The communication component 830 may enable the device 800 to communicate with other devices via a wired connection or a wireless connection. For example, the communication component 830 may include a receiver, a transmitter, a transceiver, a modem, a network interface card, or an antenna.

The device 800 may perform one or more operations or processes described herein. For example, a non-transitory computer-readable medium (e.g., memory 815) may store a set of instructions (e.g., one or more instructions or code) for execution by the processor 810. The processor 810 may execute the set of instructions to perform one or more operations or processes described herein. In some aspects, execution of the set of instructions, by one or more processors 810, causes the one or more processors 810 or the device 800 to perform one or more operations or processes described herein. In some aspects, hardwired circuitry may be used instead of or in combination with the instructions to perform one or more operations or processes described herein. Additionally, or alternatively, the processor 810 may be configured to perform one or more operations or processes described herein. Thus, aspects described herein are not limited to any specific combination of hardware circuitry and software.

In some aspects, device 800 may include means for obtaining one or more security keys; and means for communicating, to at least one of one or more devices, a provisioning service, or a device manufacturer, one or more messages during a lifetime of the product, wherein the one or more messages enable a change of ownership of the product during the lifetime of the product based at least in part on the one or more security keys. In some aspects, the means for device 800 to perform processes and/or operations described herein may include one or more components of device 800 described in connection with FIG. 8, such as bus 805, processor 810, memory 815, input component 820, output component 825, and/or communication component 830.

The number and arrangement of components shown in FIG. 8 are provided as an example. The device 800 may include additional components, fewer components, different components, or differently arranged components than those shown in FIG. 8. Additionally, or alternatively, a set of components (e.g., one or more components) of the device 800 may perform one or more functions described as being performed by another set of components of the device 800.

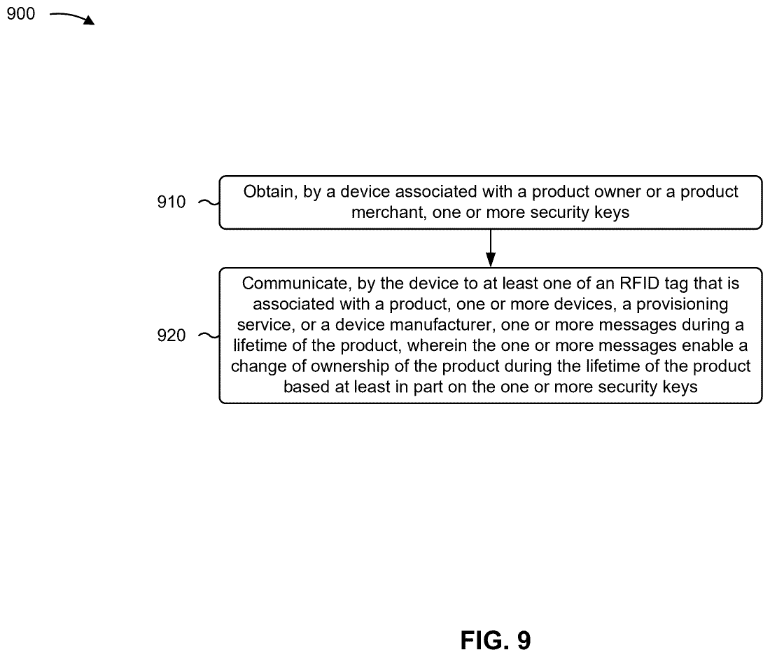

FIG. 9 is a flowchart of an example process 900 associated with establishing ownership for RFID tags associated with products. One or more process blocks of FIG. 9 are performed by a device (e.g., a device associated with a merchant or an owner as shown in FIGS. 1-7) and/or by another device or a group of devices separate from or including the device. The device may be a reader, such as an RFID reader. Additionally, or alternatively, one or more process blocks of FIG. 9 may be performed by one or more components of device 800, such as processor 810, memory 815, input component 820, output component 825, and/or communication component 830.

As shown in FIG. 9, process 900 includes obtaining, by the device associated with a product owner or a product merchant, one or more security keys (block 910). For example, the device associated with the product owner or the product merchant may obtain one or more security keys, as described above.

As further shown in FIG. 9, process 900 includes communicating, by the device to at least one of an RFID tag that is associated with a product, one or more devices, a provisioning service, or a device manufacturer, one or more messages during a lifetime of the product, wherein the one or more messages enable a change of ownership of the product during the lifetime of the product based at least in part on the one or more security keys (block 920). For example, the device may communicate, to at least one of an RFID tag that is associated with a product, one or more devices, a provisioning service, or a device manufacturer, one or more messages during a lifetime of the product, wherein the one or more messages enable a change of ownership of the product during the lifetime of the product based at least in part on the one or more security keys, as described above.

Process 900 may include additional aspects, such as any single aspect or any combination of aspects described below and/or in connection with one or more other processes described elsewhere herein.

In a first aspect, process 1000 includes receiving, by the device from the provisioning service, signaling associated with an ownership establishment; obtaining, by the device, an owner key based at least in part on a key establishment; obtaining, by the device, a transcript that indicates an ownership change; signing, by the device, the transcript to obtain a signed transcript; and transmitting, by the device, the signed transcript to the provisioning service.

In a second aspect, alone or in combination with the first aspect, process 1000 includes receiving, by the device from the RFID tag, product information that includes an EPC; transmitting, by the device, an ownership request to the provisioning service, wherein the ownership request includes one or more of the EPC, a sales record, or an authentication key; receiving, by the device from the provisioning service, a one-time authentication credential that includes the authentication key, an authorization token, and an encrypted authentication key; transmitting, by the device to the RFID tag, a command message that indicates one or more of an authorization token or an encrypted authentication key; verifying, by the device, the authentication key, wherein the authentication key is stored on the RFID tag and on the merchant device; and obtaining, by the device, an owner key based at least in part on a key exchange protocol involving the authentication key, wherein the owner key is stored on the RFID tag and on the device.

In a third aspect, alone or in combination with one or more of the first and second aspects, process 900 includes receiving, by the device from the RFID tag, product information that includes an EPC; transmitting, by the device, an ownership request to the provisioning service, wherein the ownership request includes one or more of the EPC, a sales record, an authorization token, or an authentication key; receiving, by the device from the provisioning service, a one-time authentication credential that includes the authentication key, an authorization token, and an encrypted authentication key; transmitting, by the device to the RFID tag, a command message that indicates one or more of an authorization token or an encrypted authentication key; verifying, by the device, the authentication key, wherein the authentication key is stored on the RFID tag and on the device; and obtaining, by the device, an owner key based at least in part on a key exchange protocol involving the authentication key, wherein the owner key is stored on the RFID tag and on the device.

In a fourth aspect, alone or in combination with one or more of the first through third aspects, process 900 includes transmitting, by the device to the provisioning service, an indication of an ownership release that includes one or more of an EPC or a transcript; and transmitting, by the device to the provisioning service, an ownership request that includes one or more of the EPC, an authorization token, an authentication key, or the transcript.

In a fifth aspect, alone or in combination with one or more of the first through fourth aspects, process 900 includes receiving, by the device from the RFID tag, product information that includes an EPC; transmitting, by the device to the provisioning service, an ownership release indication that includes the EPC; receiving, by the device from the provisioning service, an ownership release confirmation that includes a token; transmitting, by the device to the RFID tag, a command message that includes an indication of an ownership release and the token; and receiving, by the device from the RFID tag, a confirmation of an ownership release.

In a sixth aspect, alone or in combination with one or more of the first through fifth aspects, process 900 includes receiving, by the device from the provisioning service, signaling associated with an ownership establishment, wherein the signaling includes a certificate; obtaining, by the device, a transcript that indicates an ownership change; signing, by the device, the transcript to obtain a signed transcript; transmitting, by the device to the RFID tag, the signed transcript; and transmitting, by the device to the provisioning service, a transcript report.

In a seventh aspect, alone or in combination with one or more of the first through sixth aspects, process 900 includes receiving, by the device from the provisioning service, a public key; generating, by the device, an owner key based at least in part on the public key; transmitting, by the device to the provisioning service, an encrypted owner key, wherein the encrypted owner key is based at least in part on the owner key; obtaining, by the device, a transcript that indicates an ownership change; signing, by the device, the transcript; and transmitting, by the device to the provisioning service, a transcript report

In an eighth aspect, alone or in combination with one or more of the first through seventh aspects, the device is a reader.

Although FIG. 9 shows example blocks of process 900, in some implementations, process 900 includes additional blocks, fewer blocks, different blocks, or differently arranged blocks than those depicted in FIG. 9. Additionally, or alternatively, two or more of the blocks of process 900 may be performed in parallel.

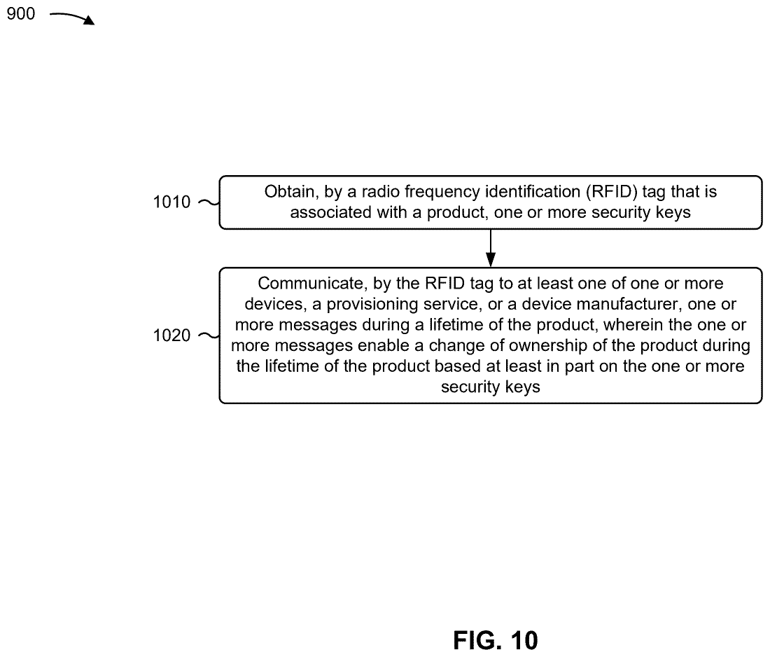

FIG. 10 is a flowchart of an example process 1000 associated with establishing ownership for RFID tags associated with products. One or more process blocks of FIG. 10 are performed by an RFID tag (e.g., an RFID tag as shown in FIGS. 1-7) that is associated with a product and/or by another device or a group of devices separate from or including the RFID tag. Additionally, or alternatively, one or more process blocks of FIG. 10 may be performed by one or more components of device 800, such as processor 810, memory 815, input component 820, output component 825, and/or communication component 830.

As shown in FIG. 10, process 1000 includes obtaining, by the RFID tag that is associated with the product, one or more security keys (block 1010). For example, the RFID tag may obtain one or more security keys, as described above.

As further shown in FIG. 10, process 1000 includes communicating, by the RFID tag to at least one of one or more devices, a provisioning service, or a device manufacturer, one or more messages during a lifetime of the product, wherein the one or more messages enable a change of ownership of the product during the lifetime of the product based at least in part on the one or more security keys (block 1020). For example, the RFID tag may communicate, to at least one of one or more devices, a provisioning service, or a device manufacturer, one or more messages during a lifetime of the product, wherein the one or more messages enable a change of ownership of the product during the lifetime of the product based at least in part on the one or more security keys, as described above.

Process 1000 may include additional aspects, such as any single aspect or any combination of aspects described below and/or in connection with one or more other processes described elsewhere herein.

In a first aspect, process 1000 includes obtaining, by the RFID tag, a device key from the device manufacturer, wherein the device key is stored on the RFID tag and at the provisioning service; determining, by the RFID tag, a first owner key based at least in part on the device key, wherein the first owner key is associated with a first owner device, and wherein the first owner key is stored on the RFID tag and on the first owner device; receiving, by the RFID tag from the provisioning service, signaling associated with an ownership establishment for a second owner associated with a second owner device, wherein the signaling is based at least in part on a transcript that indicates an ownership change between a first owner associated with the first owner device and the second owner, wherein the transcript is signed using the first owner device and the second owner device, and wherein the signaling indicates notarization information associated with the transcript; verifying, by the RFID tag, the notarization information based at least on the device key; verifying, by the RFID tag, the transcript based at least on the first owner key; and performing, by the RFID tag, a key establishment with the second owner device, wherein a second owner key is obtained based at least in part on the key establishment, and wherein the second owner key is stored on the RFID tag and on the second owner device.

In a second aspect, alone or in combination with the first aspect, process 900 includes obtaining, by the RFID tag, a device key from the device manufacturer, wherein the device key is stored on the RFID tag and at the provisioning service; transmitting, by the RFID tag to a merchant device and as part of an ownership establishment for a merchant associated with the merchant device, product information that includes an EPC, wherein an ownership request between the merchant device and the provisioning service includes one or more of the EPC, a sales record, or an authentication key; receiving, by the RFID tag from the merchant device, a command message that indicates one or more of an authorization token or an encrypted authentication key, wherein the command message is based at least in part on a one-time authentication credential from the provisioning service to the merchant device that includes the authentication key, the authorization token, and the encrypted authentication key, and wherein the encrypted authentication key is based at least in part on the device key; verifying, by the RFID tag, the authentication key, wherein the authentication key is stored on the RFID tag and on the merchant device; and obtaining, by the RFID tag, an owner key based at least in part on a key exchange protocol involving the authentication key, wherein the owner key is stored on the RFID tag and on the merchant device.

In a third aspect, alone or in combination with one or more of the first and second aspects, process 1000 includes obtaining, by the RFID tag, a device key, wherein the device key is stored on the RFID tag and at the provisioning service; transmitting, by the RFID tag to a consumer obtaining, by the RFID tag, a device key, wherein the device key is stored on the RFID tag and at the provisioning service; transmitting, by the RFID tag to a consumer device and as part of an ownership transfer between a merchant associated with a merchant device and a consumer associated with the consumer device, product information that includes an EPC, wherein an ownership request from the consumer device or the merchant device to the provisioning service includes the EPC, a sales record, and an authorization token; receiving, by the RFID tag from the consumer device, a command message that indicates one or more of the authorization token or an encrypted authentication key, wherein the command message is based at least in part on a one-time authentication credential from the provisioning service to the consumer device that includes an authentication key, the authorization token, and the encrypted authentication key, and wherein the encrypted authentication key is based at least in part on the device key; verifying, by the RFID tag, the authorization token based at least in part on a merchant key; verifying, by the RFID tag, the authentication key based at least in part on the device key, wherein the authentication key is stored on the RFID tag and on the consumer device; and obtaining, by the RFID tag, an owner key based at least in part on a key exchange protocol involving the authentication key, wherein the owner key is stored on the RFID tag and on the consumer device.

In a fourth aspect, alone or in combination with one or more of the first through third aspects, process 1000 includes obtaining, by the RFID tag, a device key, wherein the device key is stored on the RFID tag and at the provisioning service; transmitting, by the RFID tag to a second consumer device and as part of an ownership transfer between a first consumer associated with a first consumer device and a second consumer associated with the second consumer device, product information that includes an EPC, wherein an ownership request from the first consumer device or the second consumer device to the provisioning service includes one or more of the EPC, an authorization token, an authentication key, or a transcript indicating an ownership release from the first consumer to the second consumer; receiving, by the RFID tag from the second consumer device, a command message that indicates one or more of an authorization token or an encrypted authentication key, wherein the command message is based at least in part on a one-time authentication credential from the provisioning service to the second consumer device that includes the authentication key, the authorization token, and the encrypted authentication key, and wherein the encrypted authentication key is based at least in part on the device key; verifying, by the RFID tag, the authorization token based at least in part on a first consumer key, wherein the first consumer key is an owner key of the first consumer; verifying, by the RFID tag, the authentication key based at least in part on the device key, wherein the authentication key is stored on the RFID tag and on the second consumer device; and obtaining, by the RFID tag, an owner key based at least in part on a key exchange protocol involving the authentication key, wherein the owner key is stored on the RFID tag and on the second consumer device.

In a fifth aspect, alone or in combination with one or more of the first through fourth aspects, process 1000 includes obtaining, by the RFID tag, a device key, wherein the device key is stored on the RFID tag and at the provisioning service; determining, by the RFID tag, an owner key based at least in part on the device key, wherein the owner key is associated with an owner device, and wherein the owner key is stored on the RFID tag and on the owner device; transmitting, by the RFID tag to the owner device and as part of an ownership release by an owner associated with the owner device, product information that includes an EPC that is protected, wherein an ownership release indication from the owner device to the provisioning service includes the EPC; receiving, by the RFID tag from the owner device, a command message that indicates an ownership release and a token, wherein the command message is based at least in part on an ownership release confirmation from the provisioning service to the owner device that includes the token; verifying, by the RFID tag, the command message based at least in part on the owner key and the token based at least in part on the device key; transmitting, by the RFID tag to the owner device, a confirmation of the ownership release; and deleting, by the RFID tag, the owner key from a memory of the RFID tag.

In a sixth aspect, alone or in combination with one or more of the first through fifth aspects, process 1000 includes obtaining, by the RFID tag, a device key, wherein the device key is stored on the RFID tag and at the provisioning service; determining, by the RFID tag, a first owner key based at least in part on the device key, wherein the first owner key is a public key or a certificate including the public key, wherein the first owner key is associated with a first owner device, and wherein the first owner key is stored on the RFID tag and on the first owner device; receiving, by the RFID tag from the first owner device, a transcript that has been signed using a key associated with the first owner key, wherein the transcript indicates an ownership change between a first owner associated with the first owner device and a second owner associated with a second owner device, and wherein a transaction is pending based at least in part on a receipt of the transcript; verifying, by the RFID tag, the transcript using the first owner key; receiving, by the RFID tag from the second owner device, the transcript and a second owner key, wherein the transcript has been signed using a key associated with the second owner key; verifying, by the RFID tag, the transcript using the second owner key; receiving, by the RFID tag from the provisioning service, signaling to indicate that the transaction has been approved by the provisioning service, wherein the signaling is based at least in part on a transcript report received by the provisioning service from the first owner device and a transcript report received by the provisioning service from the second owner device, and wherein the transaction is complete based at least in part on a receipt of the signaling; and performing, by the RFID tag, a key establishment with the second owner device, wherein a second owner key is obtained based at least in part on the key establishment, and wherein the second owner key is stored on the RFID tag and on the second owner device.

In a seventh aspect, alone or in combination with one or more of the first through sixth aspects, process 1000 includes generating, by the RFID tag and based at least in part on an ownership establishment trigger from the provisioning service, a public key; transmitting, by the RFID tag to the provisioning service, the public key with an attestation, wherein the attestation includes a proof of device identity or information; receiving, by the RFID tag from the provisioning service, an encrypted owner key, wherein the encrypted owner key is based at least in part on an owner key that is generated by a first owner device and the public key; verifying, by the RFID tag, the encrypted owner key using a certificate associated with the provisioning service; and performing, by the RFID tag with the provisioning service, an ownership establishment for a second owner associated with a second owner device, wherein the ownership establishment is based at least in part on a transcript that indicates an ownership change between a first owner associated with the first owner device and the second owner, wherein the transcript is signed using the first owner device and the second owner device, and wherein the ownership establishment is based at least in part on a transcript report received by the provisioning service from the first owner device and a transcript report received by the provisioning service from the second owner device; and obtaining, by the RFID tag, a second owner key based at least in part on the ownership establishment, wherein the second owner key is stored on the RFID tag and on the second owner device.

In an eighth aspect, alone or in combination with one or more of the first through seventh aspects, process 1000 includes obtaining, by the RFID tag, a certificate from a trust anchor associated with the device manufacturer or a trusted certificate authority, wherein the trust anchor is a proxy for ownership establishment, and wherein an initial provisioning of the RFID tag is based at least in part on the certificate.

In a ninth aspect, alone or in combination with one or more of the first through eighth aspects, the one or more security keys include a device key, an authentication key, or an owner key, and wherein an authorization token indicates an authorization proof of ownership transfer and is created using the owner key.

Although FIG. 10 shows example blocks of process 1000, in some implementations, process 1000 includes additional blocks, fewer blocks, different blocks, or differently arranged blocks than those depicted in FIG. 10. Additionally, or alternatively, two or more of the blocks of process 1000 may be performed in parallel.

The following provides an overview of some Aspects of the present disclosure:
Aspect 1: A method, comprising: obtaining, by a device associated with a product owner or a product merchant, one or more security keys; and communicating, by the device to at least one of a radio frequency identification (RFID) tag that is associated with a product, one or more devices, a provisioning service, or a device manufacturer, one or more messages during a lifetime of the product, wherein the one or more messages enable a change of ownership of the product during the lifetime of the product based at least in part on the one or more security keys.
Aspect 2: The method of Aspect 1, further comprising: receiving, by the device from the provisioning service, signaling associated with an ownership establishment; obtaining, by the device, an owner key based at least in part on a key establishment; obtaining, by the device, a transcript that indicates an ownership change; signing, by the device, the transcript to obtain a signed transcript; and transmitting, by the device, the signed transcript to the provisioning service.
Aspect 3: The method of any of Aspects 1-2, further comprising: receiving, by the device from the RFID tag, product information that includes an electronic product code (EPC) that is protected using a device key; transmitting, by the device, an ownership request to the provisioning service, wherein the ownership request includes one or more of the EPC, a sales record, or an authentication key; receiving, by the device from the provisioning service, a one-time authentication credential that includes the authentication key, an authorization token, and an encrypted authentication key; transmitting, by the device to the RFID tag, a command message that indicates one or more of an authorization token or an encrypted authentication key; verifying, by the device, the authentication key, wherein the authentication key is stored on the RFID tag; and obtaining, by the device, an owner key based at least in part on a key exchange protocol involving the authentication key, wherein the owner key is stored on the RFID tag and on the device.
Aspect 4: The method of any of Aspects 1-3, further comprising: receiving, by the device from the RFID tag, product information that includes an electronic product code (EPC); transmitting, by the device, an ownership request to the provisioning service, wherein the ownership request includes one or more of the EPC, a sales record, an authorization token, or an authentication key; receiving, by the device from the provisioning service, a one-time authentication credential that includes the authentication key, an authorization token, and an encrypted authentication key; transmitting, by the device to the RFID tag, a command message that indicates one or more of an authorization token or an encrypted authentication key; verifying, by the device, the authentication key, wherein the authentication key is stored on the RFID tag and on the device; and obtaining, by the device, an owner key based at least in part on a key exchange protocol involving the authentication key, wherein the owner key is stored on the RFID tag and on the device.
Aspect 5: The method of any of Aspects 1-4, further comprising: transmitting, by the device to the provisioning service, an indication of an ownership release that includes one or more of an electronic product code (EPC) or a transcript; and transmitting, by the device to the provisioning service, an ownership request that includes one or more of the EPC, an authorization token, an authentication key, or the transcript.
Aspect 6: The method of any of Aspects 1-5, further comprising: receiving, by the device from the RFID tag, product information that includes an electronic product code (EPC); transmitting, by the device to the provisioning service, an ownership release indication that includes the EPC; receiving, by the device from the provisioning service, an ownership release confirmation that includes a token; transmitting, by the device to the RFID tag, a command message that includes an indication of an ownership release and the token; and receiving, by the device from the RFID tag, a confirmation of an ownership release.
Aspect 7: The method of any of Aspects 1-6, further comprising: receiving, by the device from the provisioning service, signaling associated with an ownership establishment, wherein the signaling includes a certificate; obtaining, by the device, a transcript that indicates an ownership change; signing, by the device, the transcript to obtain a signed transcript; transmitting, by the device to the RFID tag, the signed transcript; and transmitting, by the device to the provisioning service, a transcript report.
Aspect 8: The method of any of Aspects 1-7, further comprising: receiving, by the device from the provisioning service, a public key; generating, by the device, an owner key based at least in part on the public key; transmitting, by the device to the provisioning service, an encrypted owner key, wherein the encrypted owner key is based at least in part on the owner key; obtaining, by the device, a transcript that indicates an ownership change; signing, by the device, the transcript; and transmitting, by the device to the provisioning service, a transcript report.
Aspect 9: The method of any of Aspects 1-8, wherein the device is a reader.
Aspect 10: A method, comprising: obtaining, by a radio frequency identification (RFID) tag that is associated with a product, one or more security keys; and communicating, by the RFID tag to at least one of one or more devices, a provisioning service, or a device manufacturer, one or more messages during a lifetime of the product, wherein the one or more messages enable a change of ownership of the product during the lifetime of the product based at least in part on the one or more security keys.
Aspect 11: The method of Aspect 10, further comprising: obtaining, by the RFID tag, a device key from the device manufacturer, wherein the device key is stored on the RFID tag and at the provisioning service; determining, by the RFID tag, a first owner key based at least in part on the device key, wherein the first owner key is associated with a first owner device, and wherein the first owner key is stored on the RFID tag and on the first owner device; receiving, by the RFID tag from the provisioning service, signaling associated with an ownership establishment for a second owner associated with a second owner device, wherein the signaling is based at least in part on a transcript that indicates an ownership change between a first owner associated with the first owner device and the second owner, wherein the transcript is signed using the first owner device and the second owner device, and wherein the signaling indicates notarization information associated with the transcript; verifying, by the RFID tag, the notarization information based at least on the device key; verifying, by the RFID tag, the transcript based at least on the first owner key; and performing, by the RFID tag, a key establishment with the second owner device, wherein a second owner key is obtained based at least in part on the key establishment, and wherein the second owner key is stored on the RFID tag and on the second owner device.
Aspect 12: The method of any of Aspects 10-11, further comprising: obtaining, by the RFID tag, a device key from the device manufacturer, wherein the device key is stored on the RFID tag and at the provisioning service; transmitting, by the RFID tag to a merchant device and as part of an ownership establishment for a merchant associated with the merchant device, product information that includes an electronic product code (EPC) that is protected using the device key, wherein an ownership request between the merchant device and the provisioning service includes one or more of the EPC, a sales record, or an authentication key; receiving, by the RFID tag from the merchant device, a command message that indicates one or more of an authorization token or an encrypted authentication key, wherein the command message is based at least in part on a one-time authentication credential from the provisioning service to the merchant device that includes the authentication key, the authorization token, and the encrypted authentication key, and wherein the encrypted authentication key is based at least in part on the device key; verifying, by the RFID tag, the authentication key, wherein the authentication key is stored on the RFID tag and on the merchant device; and obtaining, by the RFID tag, an owner key based at least in part on a key exchange protocol involving the authentication key, wherein the owner key is stored on the RFID tag and on the merchant device.

Aspect 13: The method of any of Aspects 10-12, further comprising: obtaining, by the RFID tag, a device key, wherein the device key is stored on the RFID tag and at the provisioning service; transmitting, by the RFID tag to a consumer device and as part of an ownership transfer between a merchant associated with a merchant device and a consumer associated with the consumer device, product information that includes an electronic product code (EPC), wherein an ownership request from the consumer device or the merchant device to the provisioning service includes the EPC, a sales record, and an authorization token; receiving, by the RFID tag from the consumer device, a command message that indicates one or more of the authorization token or an encrypted authentication key, wherein the command message is based at least in part on a one-time authentication credential from the provisioning service to the consumer device that includes an authentication key, the authorization token, and the encrypted authentication key, and wherein the encrypted authentication key is based at least in part on the device key; verifying, by the RFID tag, the authorization token based at least in part on a merchant key; verifying, by the RFID tag, the authentication key based at least in part on the device key, wherein the authentication key is stored on the RFID tag and on the consumer device; and obtaining, by the RFID tag, an owner key based at least in part on a key exchange protocol involving the authentication key, wherein the owner key is stored on the RFID tag and on the consumer device.

Aspect 14: The method of any of Aspects 10-13, further comprising: obtaining, by the RFID tag, a device key, wherein the device key is stored on the RFID tag and at the provisioning service; transmitting, by the RFID tag to a second consumer device and as part of an ownership transfer between a first consumer associated with a first consumer device and a second consumer associated with the second consumer device, product information that includes an electronic product code (EPC), wherein an ownership request from the first consumer device or the second consumer device to the provisioning service includes one or more of the EPC, an authorization token, an authentication key, or a transcript indicating an ownership release from the first consumer to the second consumer; receiving, by the RFID tag from the second consumer device, a command message that indicates one or more of an authorization token or an encrypted authentication key, wherein the command message is based at least in part on a one-time authentication credential from the provisioning service to the second consumer device that includes the authentication key, the authorization token, and the encrypted authentication key, and wherein the encrypted authentication key is based at least in part on the device key; verifying, by the RFID tag, the authorization token based at least in part on a first consumer key, wherein the first consumer key is an owner key of the first consumer; verifying, by the RFID tag, the authentication key based at least in part on the device key, wherein the authentication key is stored on the RFID tag and on the second consumer device; and obtaining, by the RFID tag, an owner key based at least in part on a key exchange protocol involving the authentication key, wherein the owner key is stored on the RFID tag and on the second consumer device.

Aspect 15: The method of any of Aspects 10-14, further comprising: obtaining, by the RFID tag, a device key, wherein the device key is stored on the RFID tag and at the provisioning service; determining, by the RFID tag, an owner key based at least in part on the device key, wherein the owner key is associated with an owner device, and wherein the owner key is stored on the RFID tag and on the owner device; transmitting, by the RFID tag to the owner device and as part of an ownership release by an owner associated with the owner device, product information that includes an electronic product code (EPC) that is protected, wherein an ownership release indication from the owner device to the provisioning service includes the EPC; receiving, by the RFID tag from the owner device, a command message that indicates an ownership release and a token, wherein the command message is based at least in part on an ownership release confirmation from the provisioning service to the owner device that includes the token; verifying, by the RFID tag, the command message based at least in part on the owner key and the token based at least in part on the device key; transmitting, by the RFID tag to the owner device, a confirmation of the ownership release; and deleting, by the RFID tag, the owner key from a memory of the RFID tag.

Aspect 16: The method of any of Aspects 10-15, further comprising: obtaining, by the RFID tag, a device key, wherein the device key is stored on the RFID tag and at the provisioning service; determining, by the RFID tag, a first owner key based at least in part on the device key, wherein the first owner key is a public key or a certificate including the public key, wherein the first owner key is associated with a first owner device, and wherein the first owner key is stored on the RFID tag and on the first owner device; receiving, by the RFID tag from the first owner device, a transcript that has been signed using a key associated with the first owner key, wherein the transcript indicates an ownership change between a first owner associated with the first owner device and a second owner associated with a second owner device, and wherein a transaction is pending based at least in part on a receipt of the transcript; verifying, by the RFID tag, the transcript using the first owner key; receiving, by the RFID tag from the second owner device, the transcript and a second owner key, wherein the transcript has been signed using a key associated with the second owner key; verifying, by the RFID tag, the transcript using the second owner key; receiving, by the RFID tag from the provisioning service, signaling to indicate that the transaction has been approved by the provisioning service, wherein the signaling is based at least in part on a transcript report received by the provisioning service from the first owner device and a transcript report received by the provisioning service from the second owner device, and wherein the transaction is complete based at least in part on a receipt of the signaling; and performing, by the RFID tag, a key establishment with the second owner device, wherein a second owner key is obtained based at least in part on the key establishment, and wherein the second owner key is stored on the RFID tag and on the second owner device.

Aspect 17: The method of any of Aspects 10-16, further comprising: generating, by the RFID tag and based at least in part on an ownership establishment trigger from the provisioning service, a public key; transmitting, by the RFID tag to the provisioning service, the public key with an attestation, wherein the attestation includes a proof of device identity or information; receiving, by the RFID tag from the provisioning service, an encrypted owner key, wherein the encrypted owner key is based at least in part on an owner key that is generated by a first owner device and the public key; verifying, by the RFID tag, the encrypted owner key using a certificate associated with the provisioning service; and performing, by the RFID tag with the provisioning service, an ownership establishment for a second owner associated with a second owner device, wherein the ownership establishment is based at least in part on a transcript that indicates an ownership change between a first owner associated with the first owner device and the second owner, wherein the transcript is signed using the first owner device and the second owner device, and wherein the ownership establishment is based at least in part on a transcript report received by the provisioning service from the first owner device and a transcript report received by the provisioning service from the second owner device; and obtaining, by the RFID tag, a second owner key based at least in part on the ownership establishment, wherein the second owner key is stored on the RFID tag and on the second owner device.

Aspect 18: The method of any of Aspects 10-17, further comprising: obtaining, by the RFID tag, a certificate from a trust anchor associated with the device manufacturer or a trusted certificate authority, wherein the trust anchor is a proxy for ownership establishment, and wherein an initial provisioning of the RFID tag is based at least in part on the certificate.

Aspect 19: The method of any of Aspects 10-18, wherein the one or more security keys include a device key, an authentication key, or an owner key, and wherein an authorization token indicates an authorization proof of ownership transfer and is created using the owner key.

Aspect 20: A system configured to perform one or more operations recited in one or more of Aspects 1-19.

Aspect 21: An apparatus comprising means for performing one or more operations recited in one or more of Aspects 1-19.

Aspect 22: A non-transitory computer-readable medium storing a set of instructions, the set of instructions comprising one or more instructions that, when executed by a device, cause the device to perform one or more operations recited in one or more of Aspects 1-19.

Aspect 23: A computer program product comprising instructions or code for executing one or more operations recited in one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus at a device associated with a product owner or a product merchant, comprising:
one or more components configured to cause the device to:
obtain one or more security keys; and
communicate, to at least one of a radio frequency identification (RFID) tag that is associated with a product, one or more devices, a provisioning service, or a device manufacturer, one or more messages during a lifetime of the product, wherein the one or more messages enable a change of ownership of the product during the lifetime of the product based at least in part on the one or more security keys.

2. The apparatus of claim 1, wherein the one or more components are further configured to cause the device to:
receive, from the provisioning service, signaling associated with an ownership establishment;
obtain an owner key based at least in part on a key establishment;
obtain a transcript that indicates an ownership change;
sign the transcript to obtain a signed transcript; and
transmit the signed transcript to the provisioning service.

3. The apparatus of claim 1, wherein the one or more components are further configured to cause the device to:
receive, from the RFID tag, product information that includes an electronic product code (EPC) that is protected using a device key;
transmit, an ownership request to the provisioning service, wherein the ownership request includes one or more of the EPC, a sales record, or an authentication key;
receive, from the provisioning service, a one-time authentication credential that includes the authentication key, an authorization token, and an encrypted authentication key;
transmit, to the RFID tag, a command message that indicates one or more of an authorization token or an encrypted authentication key;
verify the authentication key, wherein the authentication key is stored on the RFID tag; and
obtain an owner key based at least in part on a key exchange protocol involving the authentication key, wherein the owner key is stored on the RFID tag and on the device.

4. The apparatus of claim 1, wherein the one or more components are further configured to cause the device to:
receive, from the RFID tag, product information that includes an electronic product code (EPC);
transmit an ownership request to the provisioning service, wherein the ownership request includes one or more of the EPC, a sales record, an authorization token, or an authentication key;
receive, from the provisioning service, a one-time authentication credential that includes the authentication key, an authorization token, and an encrypted authentication key;
transmit, to the RFID tag, a command message that indicates one or more of an authorization token or an encrypted authentication key;
verify the authentication key, wherein the authentication key is stored on the RFID tag and on the device; and
obtain an owner key based at least in part on a key exchange protocol involving the authentication key, wherein the owner key is stored on the RFID tag and on the device.

5. The apparatus of claim 1, wherein the one or more components are further configured to cause the device to:
transmit, to the provisioning service, an indication of an ownership release that includes one or more of an electronic product code (EPC) or a transcript; and
transmit, to the provisioning service, an ownership request that includes one or more of the EPC, an authorization token, an authentication key, or the transcript.

6. The apparatus of claim 1, wherein the one or more components are further configured to cause the device to:
receive, from the RFID tag, product information that includes an electronic product code (EPC);
transmit, to the provisioning service, an ownership release indication that includes the EPC;
receive, from the provisioning service, an ownership release confirmation that includes a token;
transmit, to the RFID tag, a command message that includes an indication of an ownership release and the token; and
receive, from the RFID tag, a confirmation of an ownership release.

7. The apparatus of claim 1, wherein the one or more components are further configured to cause the device to:
receive, from the provisioning service, signaling associated with an ownership establishment, wherein the signaling includes a certificate;
obtain a transcript that indicates an ownership change;
sign the transcript to obtain a signed transcript;
transmit, to the RFID tag, the signed transcript; and
transmit, to the provisioning service, a transcript report.

8. The apparatus of claim 1, wherein the one or more components are further configured to cause the device to:
receive, from the provisioning service, a public key;
generate an owner key based at least in part on the public key;
transmit, to the provisioning service, an encrypted owner key, wherein the encrypted owner key is based at least in part on the owner key;
obtain a transcript that indicates an ownership change;
sign the transcript; and
transmit, to the provisioning service, a transcript report.

9. The apparatus of claim 1, wherein the device is a reader.

10. An apparatus at a radio frequency identification (RFID) tag that is associated with a product, comprising:
one or more components configured to cause the RFID tag to:
obtain one or more security keys; and
communicate, to at least one of one or more devices, a provisioning service, or a device manufacturer, one or more messages during a lifetime of the product, wherein the one or more messages enable a change of ownership of the product
during the lifetime of the product based at least in part on the one or more security keys.

11. The apparatus of claim 10, wherein the one or more components are further configured to cause the RFID tag to:
obtain a device key from the device manufacturer, wherein the device key is stored on the RFID tag and at the provisioning service;
determine a first owner key based at least in part on the device key, wherein the first owner key is associated with a first owner device, and wherein the first owner key is stored on the RFID tag and on the first owner device;
receive, from the provisioning service, signaling associated with an ownership establishment for a second owner associated with a second owner device, wherein the signaling is based at least in part on a transcript that indicates an ownership change between a first owner associated with the first owner device and the second owner, wherein the transcript is signed using the first owner device and the second owner device, and wherein the signaling indicates notarization information associated with the transcript;
verify the notarization information based at least on the device key;
verify the transcript based at least on the first owner key; and
perform a key establishment with the second owner device, wherein a second owner key is obtained based at least in part on the key establishment, and wherein the second owner key is stored on the RFID tag and on the second owner device.

12. The apparatus of claim 10, wherein the one or more components are further configured to cause the RFID tag to:
obtain a device key from the device manufacturer, wherein the device key is stored on the RFID tag and at the provisioning service;
transmit, to a merchant device and as part of an ownership establishment for a merchant associated with the merchant device, product information that includes an electronic product code (EPC) that is protected using the device key, wherein an ownership request between the merchant device and the provisioning service includes one or more of the EPC, a sales record, or an authentication key;
receive, from the merchant device, a command message that indicates one or more of an authorization token or an encrypted authentication key, wherein the command message is based at least in part on a one-time authentication credential from the provisioning service to the merchant device that includes the authentication key, the authorization token, and the encrypted authentication key, and wherein the encrypted authentication key is based at least in part on the device key;
verify the authentication key, wherein the authentication key is stored on the RFID tag and on the merchant device; and
obtain an owner key based at least in part on a key exchange protocol involving the authentication key, wherein the owner key is stored on the RFID tag and on the merchant device.

13. The apparatus of claim 10, wherein the one or more components are further configured to cause the RFID tag to:
obtain a device key, wherein the device key is stored on the RFID tag and at the provisioning service;
transmit, to a consumer device and as part of an ownership transfer between a merchant associated with a merchant device and a consumer associated with the consumer device, product information that includes an electronic product code (EPC), wherein an ownership request from the consumer device or the merchant device to the provisioning service includes the EPC, a sales record, and an authorization token;
receive, from the consumer device, a command message that indicates one or more of the authorization token or an encrypted authentication key, wherein the command message is based at least in part on a one-time authentication credential from the provisioning service to the consumer device that includes an authentication key, the authorization token, and the encrypted authentication key, and wherein the encrypted authentication key is based at least in part on the device key;
verify the authorization token based at least in part on a merchant key;
verify the authentication key based at least in part on the device key, wherein the authentication key is stored on the RFID tag and on the consumer device; and
obtain an owner key based at least in part on a key exchange protocol involving the authentication key, wherein the owner key is stored on the RFID tag and on the consumer device.

14. The apparatus of claim 10, wherein the one or more components are further configured to cause the RFID tag to:
obtain a device key, wherein the device key is stored on the RFID tag and at the provisioning service;
transmit, to a second consumer device and as part of an ownership transfer between a first consumer associated with a first consumer device and a second consumer associated with the second consumer device, product information that includes an electronic product code (EPC), wherein an ownership request from the first consumer device or the second consumer device to the provisioning service includes one or more of the EPC, an authorization token, an authentication key, or a transcript indicating an ownership release from the first consumer to the second consumer;
receive, from the second consumer device, a command message that indicates one or more of an authorization token or an encrypted authentication key, wherein the command message is based at least in part on a one-time authentication credential from the provisioning service to the second consumer device that includes the authentication key, the authorization token, and the encrypted authentication key, and wherein the encrypted authentication key is based at least in part on the device key;
verify the authorization token based at least in part on a first consumer key, wherein the first consumer key is an owner key of the first consumer;
verify the authentication key based at least in part on the device key, wherein the authentication key is stored on the RFID tag and on the second consumer device; and
obtain an owner key based at least in part on a key exchange protocol involving the authentication key, wherein the owner key is stored on the RFID tag and on the second consumer device.

15. The apparatus of claim 10, wherein the one or more components are further configured to cause the RFID tag to:
obtain a device key, wherein the device key is stored on the RFID tag and at the provisioning service;
determine an owner key based at least in part on the device key, wherein the owner key is associated with an owner device, and wherein the owner key is stored on the RFID tag and on the owner device;
transmit, to the owner device and as part of an ownership release by an owner associated with the owner device, product information that includes an electronic product code (EPC) that is protected, wherein an ownership release indication from the owner device to the provisioning service includes the EPC;
receive, from the owner device, a command message that indicates an ownership release and a token, wherein the command message is based at least in part on an ownership release confirmation from the provisioning service to the owner device that includes the token;
verify the command message based at least in part on the owner key and the token based at least in part on the device key;
transmit, to the owner device, a confirmation of the ownership release; and
delete the owner key from a memory of the RFID tag.

16. The apparatus of claim 10, wherein the one or more components are further configured to cause the RFID tag to:
obtain a device key, wherein the device key is stored on the RFID tag and at the provisioning service;
determine a first owner key based at least in part on the device key, wherein the first owner key is a public key or a certificate including the public key, wherein the first owner key is associated with a first owner device, and wherein the first owner key is stored on the RFID tag and on the first owner device;
receive, from the first owner device, a transcript that has been signed using a key associated with the first owner key, wherein the transcript indicates an ownership change between a first owner associated with the first owner device and a second owner associated with a second owner device, and wherein a transaction is pending based at least in part on a receipt of the transcript;
verify the transcript using the first owner key;
receive, from the second owner device, the transcript and a second owner key, wherein the transcript has been signed using a key associated with the second owner key;
verify the transcript using the second owner key;
receive, from the provisioning service, signaling to indicate that the transaction has been approved by the provisioning service, wherein the signaling is based at least in part on a transcript report received by the provisioning service from the first owner device and a transcript report received by the provisioning service from the second owner device, and wherein the transaction is complete based at least in part on a receipt of the signaling; and
perform a key establishment with the second owner device, wherein a second owner key is obtained based at least in part on the key establishment, and wherein the second owner key is stored on the RFID tag and on the second owner device.

17. The apparatus of claim 10, wherein the one or more components are further configured to cause the RFID tag to:
generate, based at least in part on an ownership establishment trigger from the provisioning service, a public key;
transmit, to the provisioning service, the public key with an attestation, wherein the attestation includes a proof of device identity or information;
receive, from the provisioning service, an encrypted owner key, wherein the encrypted owner key is based at least in part on an owner key that is generated by a first owner device and the public key;
verify the encrypted owner key using a certificate associated with the provisioning service; and
perform, with the provisioning service, an ownership establishment for a second owner associated with a second owner device, wherein the ownership establishment is based at least in part on a transcript that indicates an ownership change between a first owner associated with the first owner device and the second owner, wherein the transcript is signed using the first owner device and the second owner device, and wherein the ownership establishment is based at least in part on a transcript report received by the provisioning service from the first owner device and a transcript report received by the provisioning service from the second owner device; and
obtain a second owner key based at least in part on the ownership establishment, wherein the second owner key is stored on the RFID tag and on the second owner device.

18. The apparatus of claim 10, wherein the one or more components are further configured to cause the RFID tag to:
obtain a certificate from a trust anchor associated with the device manufacturer or a trusted certificate authority, wherein the trust anchor is a proxy for ownership establishment, and wherein an initial provisioning of the RFID tag is based at least in part on the certificate.

19. The apparatus of claim 10, wherein the one or more security keys include a device key, an authentication key, or an owner key, and wherein an authorization token indicates an authorization proof of ownership transfer and is created using the owner key.

20. A method, comprising:
obtaining, by a radio frequency identification (RFID) tag that is associated with a product, one or more security keys; and
communicating, by the RFID tag to at least one of one or more devices, a provisioning service, or a device manufacturer, one or more messages during a lifetime of the product, wherein the one or more messages enable a change of ownership of the product during the lifetime of the product based at least in part on the one or more security keys.
